(19) United States
(12) Patent Application Publication
(10) Pub. No.: US 2013/0259296 A1
(43) Pub. Date: Oct. 3, 2013

(54) ADDRESS RECOGNITION DEVICE AND ADDRESS RECOGNITION SYSTEM

(71) Applicant: KABUSHIKI KAISHA TOSHIBA, Tokyo (JP)

(72) Inventors: Masaya MAEDA, Kanagawa (JP); Tomoyuki HAMAMURA, Tokyo (JP); Ying PIAO, Tokyo (JP); Bunpei IRIE, Kanagawa (JP)

(21) Appl. No.: 13/794,328

(22) Filed: Mar. 11, 2013

(30) Foreign Application Priority Data
Mar. 15, 2012 (JP) 2012-059325

(51) Int. Cl. G06K 9/62

(52) U.S. Cl. CPC G06K 9/62
USPC 382/101

(57) ABSTRACT

An address recognition device includes a recognition information acquisition unit for acquiring information from deliverable pieces, a search unit for searching the positional information of the pieces received from the server, a correction coefficient storing unit for storing the positional information and a correction coefficient based on information acquired from the recognition information acquisition unit, a correction coefficient changing unit for changing the correction coefficient stored in the correction coefficient storing unit, an image acquisition unit for acquiring images pieces, an evaluation value calculation unit for calculating the evaluation value before the correction for the positional information based on the images, an evaluation value correction unit for correcting the evaluation value before the correction with the correction coefficient and calculating the evaluation value after the correction, and a recognition unit for recognizing the address of the receiver of the piece based on the evaluation value after the correction.

### CROSS-REFERENCE TO RELATED APPLICATION

This application is based upon and claims the benefit of priority from Japanese Patent Application No. 2012-059325, filed Mar. 15, 2012; the entire contents of which are incorporated herein by reference.

### FIELD

Embodiments described herein relate to an address recognition device and an address recognition system.

### BACKGROUND

Conventional sorting devices, for sorting pieces such as mails or parcels, i.e., pieces, have used address recognition devices to recognize addresses written on the pieces. The sorting device sorts the pieces based on the results for the address recognition.

A problem arises for many pieces in which the addresses of both the sender and the receiver are written on the pieces. The inclusion of both the sender and receiver address on the piece has led conventional address recognition devices to mistakenly recognize the sender's address for the receiver's address. As a result, pieces have inadvertently been sent to the wrong, i.e., sender's, address.

### DESCRIPTION OF THE DRAWINGS

FIG. 1 is a drawing to explain an example of the address recognition system, according to an embodiment.

FIG. 2 is a drawing of an example receiving terminal, according to an embodiment.

FIG. 3 is an example of the conversion process from the coordinate information to the positional information, according to an embodiment.

FIG. 4 is an example of the conversion process of the store ID to the positional information, according to an embodiment.

FIG. 5 is a drawing of an example registration information stored in the server, according to an embodiment.

FIG. 6 is a drawing of an example sorting device, according to an embodiment.

FIG. 7 is a drawing to explain an example of the address recognition system, according to an embodiment.

FIG. 8 is a drawing to explain an example of the address recognition system, according to an embodiment.

### DETAILED DESCRIPTION

In general, according to one example and using the figures, the disclosure will be explained in detail regarding the address recognition device and the address recognition system.

The address recognition device includes a recognition information acquisition unit configured to acquire recognition information from the pieces, a search unit configured to search the positional information showing the position where the pieces are received from the server connected through the network, based on the recognition information acquired from the recognition information acquisition unit, a correction coefficient storing unit configured to store the positional information and the correction coefficient, a correction coefficient changing unit configured to change the correction coefficient stored in the correction coefficient storing unit according to the positional information searched by the search unit, an image acquisition unit configured to acquire images from the pieces, an evaluation unit configured to calculate the evaluation value before the correction for each information based on the images, an evaluation value correction unit configured to correct the evaluation value before the correction using the correction coefficient and to calculate the evaluation value after the correction, and a recognition unit configured to recognize the address of the receiver of the piece based on the evaluation value after the correction. In the embodiment, to reduce the incidence of routing a letter, package or other item, hereinafter a piece or pieces, to the originating address, the piece is encoded with information relating to its origin. This information is used when the piece is routed in an automated routing facility, to assess the accuracy of the destination decision or the automated routing system where the destination and initiation address are both on the piece, and there is a risk of mistakenly reading the origination address as the destination address. For example, the origin information may be used to create a correlation value, and that value is used to later compare to a destination address, to judge the validity thereof.

FIG. 1 shows the configuration of an example of an address recognition system 100. The address recognition system 100 includes a receiving terminal 10, a server 30, a sorting device 50, and a sorting device 70, and the like.

The receiving terminal 10 is a terminal which is used by staff, i.e., individuals, who have collected pieces of mail, parcels, etc. The staff receives pieces from a sender, whereupon the receiving terminal 10 reads the recognition information written on a label attached to the piece, and carries out various steps. The receiving terminal 10 can be configured to print the recognition information on to, for example, a sticker, and place that sticker on the piece, if relevant machine readable information is not attached to the piece. The receiving terminal 10 generates the recognition information according to input by a staff person.

The server 30 is connected to the receiving terminal 10, the sorting device 50, and the sorting device 70 through a network. The server 30 includes a memory device to store the registration information generated by the receiving terminal 10. In addition, the server 30 distributes the registration information in response to a request from the sorting device 50 or the sorting device 70.

The sorting device 50 is a device provided in the collection vehicle (the first collecting place) of the piece operation. The sorting device 50 reads the address written on the collected piece and sorts the piece into sorting receptacles based on broad geographic destination criteria, for example, local destination, regional destination, certain selected major city destinations, etc. The pieces sorted by the sorting device 50 are then sent to a collection facility corresponding to the sorted destination criteria (the secondary collection location).

The sorting device 70 is a device provided in the collection center (the second collecting place) of the piece operation. Here, the sorting device 70 has the same configuration as the sorting device 50. Pieces sorted by the sorting device 70 will ultimately be delivered to the recipients of the address of the receiver.

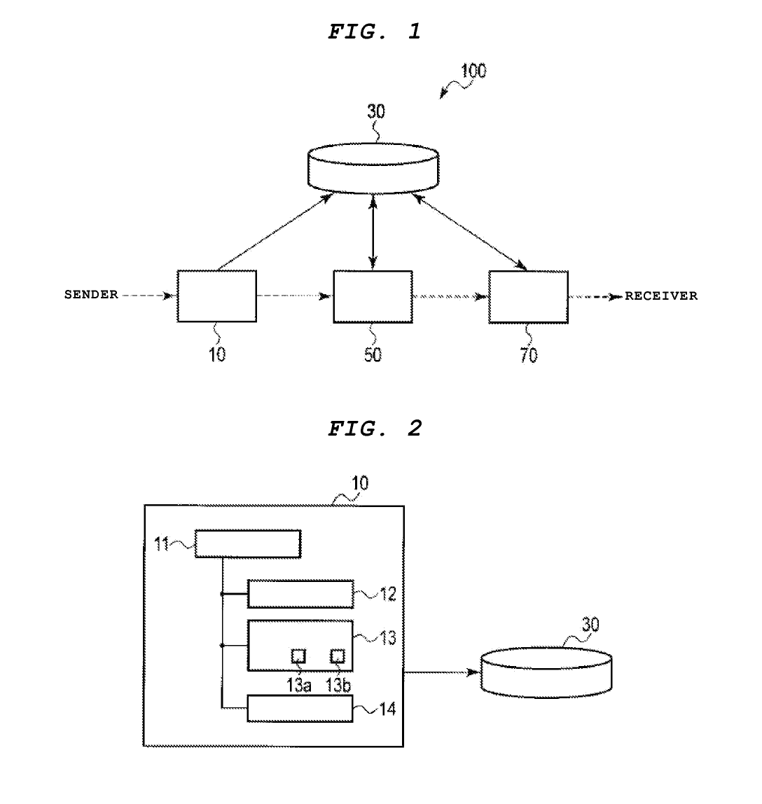

FIG. 2 shows an example of the receiving terminal 10. As mentioned above, the receiving terminal 10 registers the articles to be delivered (pieces) brought by the sender to the original collecting location.

The receiving terminal 10 includes a control unit 11, an ID assigning unit 12, a position specifying unit 13, and a registration unit 14.

The control unit 11 controls all aspects of the operation of the receiving terminal 10. The control unit 11 includes a CPU, a buffer memory, a program memory, non-volatile memory and so on. The CPU carries out various calculations. The buffer memory temporarily stores the result of the calculation carried out by the CPU. The program memory and the non-volatile memory store the various programs that the CPU carries out, including control data, and the like. The control unit 11 can execute various processes by executing the programs stored in the program memory by the CPU.

The ID assigning unit 12 generates recognition information for each piece brought to the collecting location for forwarding or mailing thereof. The recognition information can be any information sufficient to specify the delivery location of the piece, as required by the operator of the delivery system. For example, the ID assigning unit 12 can be configured to read a voucher number of a voucher attached to the piece, and to use the voucher number that it reads as the recognition information. Also, the ID assigning unit 12 can be configured to print and issue the recognition information on such a medium as a sticker, if a voucher specifying addressee or recipient information is not already attached to the piece.

The position specifying unit 13 generates the information showing the collecting location address (or geographic coordinates or other position information) of the piece (positional information) for which the recognition information is generated. For example, the position specifying unit 13 can be configured to generate the positional information through the function such as GPS. In this case, the position specifying unit 13 generates the coordinate information by the GPS. The position specifying unit 13 may generate specific positional information by referring to the table in which the coordinate information and the positional information are correlated in advance.

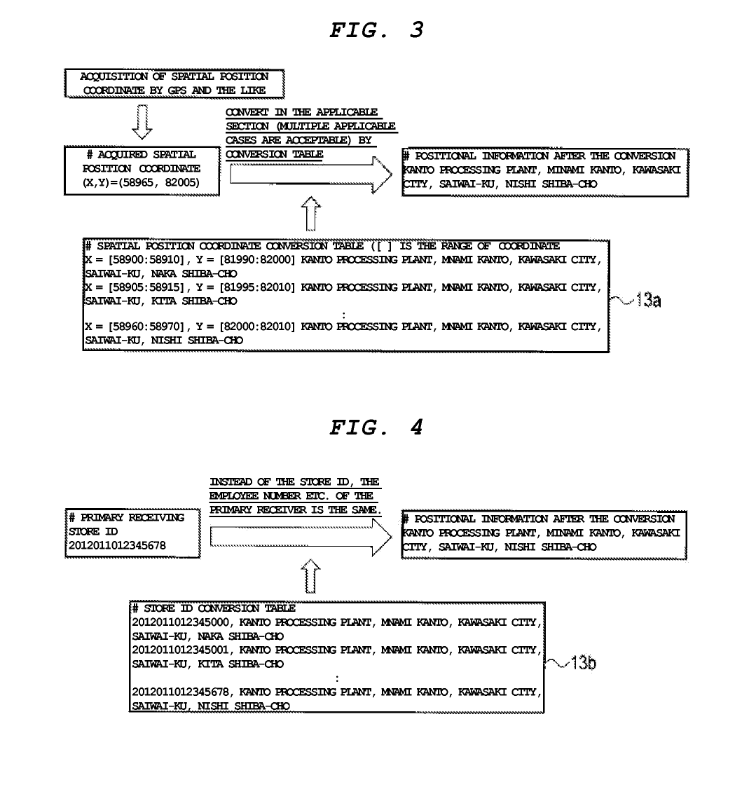

FIG. 3 shows an example of the conversion process from the coordinate information to the positional information. As shown in FIG. 3, the position specifying unit 13 includes a memory 13a which stores a table in which the coordinate information such as GPS coordinates, and positional information such as a physical address corresponding to a GPS coordinate, are correlated to each other. The position specifying unit 13 refers to the table stored in the memory 13a, and reads out the positional information corresponding to the coordinate information.

Also, the position specifying unit 13 can be configured to generate the positional information based on the set of information pre-set at each collecting place which collected the piece and so on. For example, the position specifying unit 13 generates the ID of a store, a kiosk, etc, which is the collecting place of the piece, and the like, which may be entered manually, by the staff of the store, kiosk, etc where the piece is received. The position specifying unit 13 generates specific positional information by referring to the table in which the store ID and the positional information are correlated to each other in advance.

FIG. 4 shows an example of the process of converting a store ID i.e., a unique identifier of a location where a sender deposits a piece for mailing or forwarding into positional information of where the piece was offered or deposited for mailing or forwarding. As shown in FIG. 4, the position specifying unit 13 includes a memory 13b, which stores the table in which the store ID and the positional information are correlated. The position specifying unit 13 reads out the positional information corresponding to the store ID by referring to the table stored in the memory 13b.

Furthermore, where a member of staff directly collects the piece and the charge is assigned in advance, the position specifying unit 13 can be configured to generate the positional information based on a number specifically assigned to the collecting staff member or person. Also, the position specifying unit 13 can be configured to generate the positional information based on the information attached to the receiving terminal 10 as specific information.

Here, the positional information, as shown in FIG. 3 and FIG. 4, can be set in the table as a classification when the area in charge is seen in detail or when the area in charge is seen in a wide range. In this way, the receiving terminal 10 can make various adjustments according to the operational policy by relating the positional information to a variety of information.

The registration unit 14 executes the process in which the recognition information for each piece and the positional information are registered to the server 30. In other words, the registration unit 14 relates the recognition information generated by the ID assigning unit 12 to the positional information generated by the position specifying unit 13, and sends them to the server 30 as the registration information. The server 30 stores the registration information sent from the receiving terminal 10 as a database.

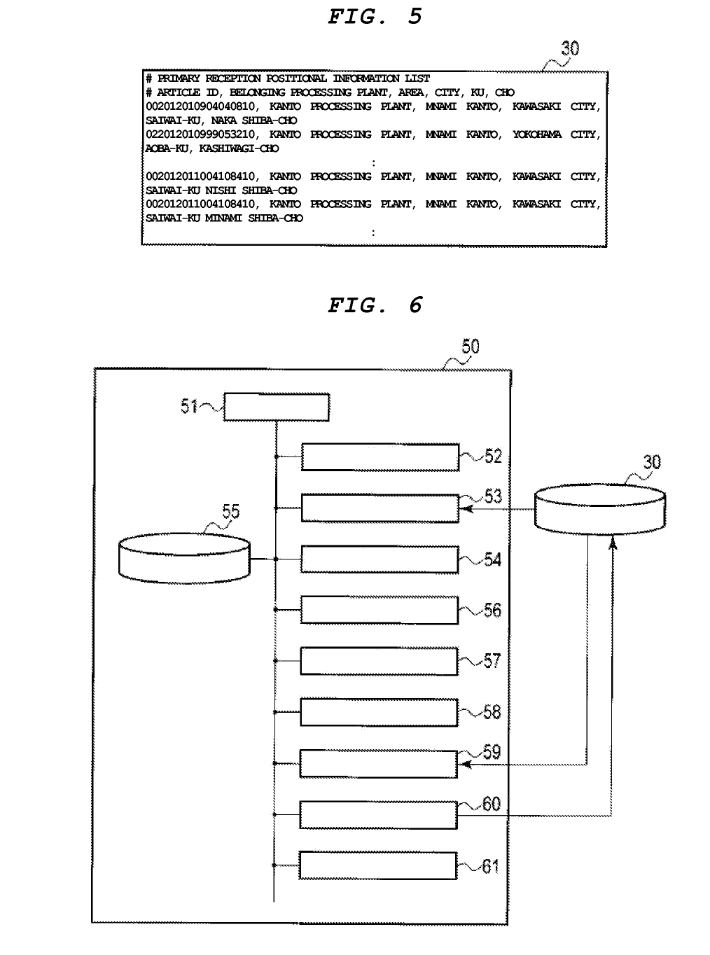

FIG. 5 shows an example of the registration information stored in the server. As shown in FIG. 5, the server 30 stores the recognition information (article ID) corresponding to the positional information (i.e., processing facility, area, city, ward and town). The server 30 can send the registration information for each piece of recognition information, in response to the request by the sorting device 50 or the sorting device 70.

Here, in actual operations, the coded information requires less volume in the list itself and is more easily accessed by the program. Therefore, the actual letter rows at the processing facility can be a coded list by number rows and so on.

For example, the registration unit 14 sends the registration information to the server 30 at the time of the receipt of the piece, along with the payment status of the fee and receipt status of the piece. Here, the registration unit 14 can be configured to send such information as the payment status of the fee and receipt status of the piece, and the like. to another server. In this case, the registration unit 14 sends data to the server in such a way that the registration information, the payment status of the fee and the receipt status of the piece are linked.

Furthermore, the method of connecting the piece to the recognition information for the piece is not limited to the above-mentioned voucher number system, or to a system using a sticker, on which the recognition information is printed, but any methods are fine. For example, an electric wireless tag in which the recognition information is stored can be attached to the piece. It can also be a method where the primary barcode, which includes the recognition information or a second barcode, is printed out and attached to the piece. In other words, any method can be used as long as it can provide the original recognition information by some means from the piece.

The pieces to be sorted are transported to the piece collection center (the first collecting place) by a contracted distributor, once receipt thereof is completed. As mentioned above, the sorting device 50 is provided at the first collecting place.

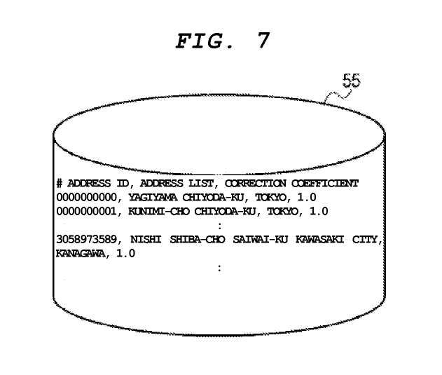

FIG. 6 shows an example of the sorting device 50. As mentioned above, the sorting device 50 sorts the pieces which have been through the receiving process to each piece area. The sorted pieces are then transported to the collection center (the second collecting place) by a contracted carrier.

The sorting device 50 includes a control unit 51, an ID recognition unit 52, a search unit 53, a correction coefficient change unit 54, a correction coefficient memory 55, an image reading unit 56, an evaluation value calculation unit 57, an evaluation value correction unit 58, an evaluation value comparison unit 59, a recognition result registration unit 60 and a sorting unit 61.

The control unit 51 controls the operation of the sorting device 50. The control unit 51 includes the CPU, a buffer memory, a program memory, a non-volatile memory and so on. The CPU carries out various calculations. The buffer memory temporarily stores the result of calculations carried out by the CPU. The program memory and the non-volatile memory store various programs executed by the CPU, the control data and so on. The control unit 51 can execute various processes by executing the programs stored in the program memory by the CPU.

The ID recognition unit 52 acquires the recognition information from the pieces. For example, if the voucher number is used as the recognition information, the ID recognition unit 52 recognizes the recognition information by optically reading the voucher number or the barcode corresponding to the voucher number. Also, if a sticker on which the recognition information is printed is attached to the piece, the ID recognition unit 52 recognizes the recognition information by optically reading the sticker. Also, if an electronic tag in which the recognition information is stored is attached to the piece, the ID recognition unit 52 recognizes the recognition information by reading the electronic tag with a wireless reader.

The search unit 53 retrieves from the server 30 the registration information corresponding to the recognition information acquired by the ID recognition unit 52. In other words, the search unit 53 sends the recognition information and request to the server 30. The server 30 reads out the registration information including the received recognition information and returns it to the sorting device 50. In this way, the search unit 53 can acquire the registration information corresponding to the recognition information acquired from the piece.

Also, in order to avoid wasting time by communicating with the server 30 each time a piece is processed; the sorting device 50 can be configured to download a list of registration information from the server 30 in advance when it starts sorting multiple pieces . In this case, the sorting device 50 can search the registration information in a local environment. Also, if the registration information for all the pieces has been acquired, there is a possibility that the volume of data becomes too large. Therefore, the sorting device 50 can be configured to download in advance from the server 30 the registration information for an item that coincides with that for the collection center where the sorting device 50 is located.

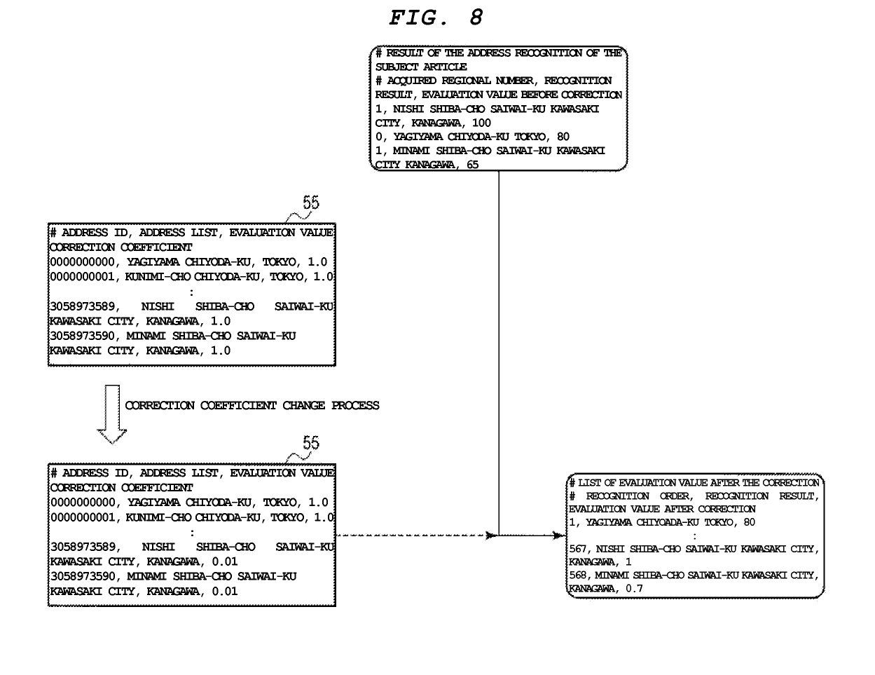

The correction coefficient change unit 54 executes the process to change the correction coefficient for each area according to the acquired registration information. The correction coefficient memory 55 is a memory which stores the correction coefficient for each area. The correction coefficient memory 55, for example as shown in FIG. 7, memorizes the address ID, the address list and the correction coefficient in such a way that they correspond with each other. Here, the correction coefficient is set to be 1.0 at the standard state.

The correction coefficient change unit 54 changes the correction coefficient stored in the correction coefficient memory 55, using the location or positional information of the registration information acquired by the search unit 53. In other words, the correction coefficient change unit 54 changes the correction coefficient stored in the correction coefficient memory 55, by using the positional information created at the time of acceptance of the piece.

Assuming that there is a low possibility for a piece to be transported to the same area in which the piece is accepted, the correction coefficient change unit 54 sets the correction coefficient for the area which coincides with the area provided in the positional information at the time of acceptance to be lower than the standard correction coefficient.

For example, as shown in FIG. 8, consider the case in which the positional information for a piece at the time of acceptance is “belonging to processing facility: Kanto Processing Facility,” “area: Minami Kanto,” “city: Kawasaki City, “” ward: Saiwai-ku, “” town: Nishi Shiba-cho” In this case, the correction coefficient change unit 54 sets the correction coefficient for the applicable candidates in the correction coefficient memory 55 to be lower than the standard correction coefficient.

By this means, when a sender's address and the piece address are read as the delivery address in a later process, the evaluation value of the sender side address is reduced accordingly. Thus, the sorting device 50 can accurately recognize the receiving address. Here, the reduction rate of the correction coefficient is set within the preset range. For example, in case the correction coefficient of the area that coincided with the positional or location information at the time of acceptance is reduced at the maximum reduction rate, the sorting device 50 is in the state in which the area that coincides with the positional information at the time of acceptance will be completely unrecognizable as a piece address.

The image reading unit 56 reads the image from the piece. The image reading unit 56, for example, includes a light and an optical sensor. The light shines on the piece. The optical sensor includes a photo detector such as a charge coupled device (CCD), and an optical system (lens) . The optical sensor receives the reflected light which is reflected by the piece, forms images at the CCD, and acquires electric signals (images) . The image reading unit 56 can acquire the image in a location where the address is written on the piece by acquiring the image according to the reflected light irradiated onto the piece.

The evaluation value calculation unit 57 recognizes the address based on the image of the region in which the address of the piece acquired by the image reading unit 56 is written.

For example, the evaluation value calculation unit 57 extracts address candidates to specify the position where addresses are written on the piece. The evaluation value calculation unit 57 designates as “1” those areas in which the difference in the luminosity value between the adjacent picture elements in the acquired multi-level image is over a specified value and designates the other areas of the image as “0” to produce a differentiated two-level image. The evaluation value calculation unit 57 connects the areas designated as 1 in the differentiated two-level image, and produces a differentiated label. The evaluation value calculation unit 57 produces the address row candidates by integrating each of the differentiated labels based on their mutual positional relations. The evaluation value calculation unit 57 examines the sizes and alignment of the labels, and registers the detected row candidates that satisfy the conditions.

Next, the evaluation value calculation unit 57 produces the address region candidates corresponding to the positional relationship of each of the multiple registered address candidates from the image. In other words, the address region candidates will include at least one or more address candidates.

Next, the evaluation value calculation unit 57 matches the multiple extracted address region candidates with the address database. Here, the address database has the same configuration as the address ID and address lists stored in the correction coefficient memory 55. By this means, the evaluation value calculation unit 57 can calculate the evaluation value before correction for each list in the address database.

The evaluation value correction unit 58 corrects the evaluation value before the correction, calculated by the evaluation value calculation unit 57, using the correction coefficient stored in the correction coefficient memory 55, and calculates the evaluation value after the correction. The evaluation value correction unit 58 calculates the evaluation value after the correction by multiplying or adding, to the evaluation value before the correction calculated on a certain list (area), the correction coefficient of the same area. Here, as mentioned above, the correction coefficient of the area that received the piece is set to be low. By this means, the sorting device 50 can keep the evaluation value after the correction of the receiving area to be low.

If the receiving area is “Nishi Shiba-cho Saiwai-ku Kawasaki City,” the correction coefficient change unit 54 sets the correction coefficient corresponding to “Nishi Shiba-cho Saiwai-ku Kawasaki City” in the correction coefficient memory 55 to be low. For example, as shown in FIG. 8, suppose the evaluation value before the correction for the area “Nishi Shiba-cho Saiwai-ku Kawasaki City” is “100,” the evaluation value before the correction for the area “Yagiyama Chiyoda-ku Tokyo” is “80.” Also, suppose the correction coefficient for the area “Nishi Shiba-cho Saiwai-ku Kawasaki City” is “0.01,” and the correction coefficient for the area “Yagiyama Chiyoda-ku Tokyo” is “1.0.” In this case, the evaluation value after the correction for the area “Nishi Shiba-cho Saiwai-ku Kawasaki City” is “1,” and the evaluation value after the correction for the area “Yagiyama Chiyoda-ku Tokyo” is “80.” Thus, if both addresses are read in the processing station, the Kawasaki address will be ignored.

In this way, by setting the correction coefficient low according to the positional information at the time of the receiving, the evaluation value of the sender's address recognition result after the correction can be corrected to be low.

The evaluation value comparison unit 59 compares multiple evaluation values after the correction, corrected by the evaluation value correction unit 58. The evaluation value comparison unit 59 specifies the piece address based on the comparison result. For example, the evaluation value comparison unit 59 acquires the target address recognition result by selecting the candidate for which the highest value is calculated.

The recognition result registration unit 60 executes the registration process of the recognition result in which the recognition result of the address is registered to the server 30. The recognition result registration unit 60 sends the recognition result by the evaluation value comparison unit 59 to the server 30, once the recognition of the piece address by the evaluation value comparison unit 59 is completed. In this way, the sorting device 50 can prevent the recognition process for the same piece from getting repeated by a sorting device provided at another collecting center. Also, the recognition result registration unit 60 can be configured to attach a sticker, and the like, on which a barcode with a coded recognition result of the piece address is printed, on the delivered goods.

The control unit 51 resets the value of the correction coefficient stored in the correction coefficient memory 55 back to the standard value, once the recognition of address for one piece is completed.

The sorting unit 61 sorts pieces based on the recognition result of the piece address. For example, the sorting unit 61 includes a conveyance path for conveying pieces, multiple collection warehouses to collect multiple pieces at each area, and multiple gates to divert the conveyance path to multiple warehouses. The sorting unit 61 transports the pieces to the warehouse corresponding to the area of the piece by controlling the gate based on the recognition result of the piece address . By this, the pieces are sorted to each area of the piece.

Also, the sorting device 70 provided at the second collecting place can be configured to acquire the recognition result of the piece address from the server 30. As mentioned above, the sorting device 50 provided at the first collecting place sends the piece address to the server 30, which can store the ID of the piece corresponding to the piece address. The sorting device 70 provided at the second collecting place can acquire the piece address recognized by other sorting devices from the server 30 according to the recognition information acquired from the articles to be delivered.

Also, when the address of the received piece which has been recognized by another sorting device is printed as a barcode or the secondary code, the sorting device 70 can acquire the address of the received package by reading the barcode or the secondary code.

As discussed above, the address recognition system 100 registers the information showing the receiving area for each piece to the server by the receiving terminal 10. The sorting device 50 recognizes the receiving area registered in the server, and executes the recognition process by setting the correction coefficient of the receiving area lower than the correction coefficients of the other areas.

In this way, the possibility of the receiving area being recognized as the receiver's areas can be suppressed. The sorting device 50 can prevent the sender's address and the receiver's address from being recognized mistakenly. As a result, an address recognition device and an address recognition system that can recognize the receiver's address with higher precision can be provided.

Also, the address recognition system 100 can produce a detailed customer database by registering the detailed address (block, building name, company name, name and so on) from the address recognition results. The address recognition system 100 can also collect statistics such as the number quantity of pieces submitted by the same customer. For example, because the receiving positional information is registered in the server 30, the address recognition system 100 can acquire the information to the level of the town name by communicating with the server 30.

However, the server 30 is expected to be accessed by the collection facilities across the country. Therefore, it is not realistic to register and retain all the company names or individual names for each piece, from the viewpoint of the amount of data and variations. In such a case, it becomes important to be able to recognize the sender accurately, rather than the recipient.

In order to recognize the sender's address correctly, for example, the correction coefficient change unit 54 sets the correction coefficient of the region corresponding to the registered information larger than the standard correction coefficient. Therefore, the sorting device 50 can recognize the sender's address correctly even if the sender's address and other addresses are extracted on multiple occasions, because the correction coefficient of the sender is large.

For example, in case the sender's address is recognized by the collection facility (sorting facility) of the sender of the piece, it is enough for the sorting device 50 to have the address database which includes the detailed information—such as the block of the collection facility (sorting facility) of the sender, the name of the building, the name of the company and the name of the individual. In other words, the sorting device 50 does not have to possess a detailed address database for the entire country in order that it can actualize the configuration more easily than the method in which detailed addresses of the entire country are registered by the server 30.

Here the functions in each embodiment explained above are not limited to being configured by hardware but can also be actuated by making the computer read a program in which each function is written by software. Also, each function can be configured to select as appropriate either software or hardware.

While certain embodiments have been described, these embodiments have been presented by way of example only, and are not intended to limit the scope of the inventions . Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An address recognition device, comprising:
a recognition information acquisition unit configured to acquire recognition information from a piece;
a search unit configured to search positional information showing location of where the piece is received, based on the recognition information, from a server connected through a network;
a correction coefficient storing unit configured to store the positional information and a correction coefficient;
a correction coefficient change unit configured to change the correction coefficient according to the positional information;
an image acquisition unit configured to acquire images from the piece;
an evaluation value calculation unit configured to calculate an evaluation value before making a correction to location information based on the images;
an evaluation value correction unit configured to correct the evaluation value before correction with the correction coefficient and to calculate the evaluation value after the correction; and
a recognition unit configured to recognize an address of a receiver of the piece based on the evaluation value after the correction.

2. The address recognition device according to claim 1, wherein the correction coefficient change unit reduces the correction coefficient corresponding to the positional information searched by the search unit, if the recognition unit recognizes the address of the receiver of the piece.

3. The address recognition device according to claim 1, wherein the correction coefficient change unit increases the correction coefficient corresponding to the positional information searched by the search unit, if the recognition unit recognizes the address of a sender of the piece.

4. The address recognition device according to claim 1, wherein the search unit acquires pre-set positional information and the recognition information corresponding to the positional information from the server in advance.

5. The address recognition system according to claim 1, wherein the correction coefficient stored in the correction coefficient storing unit is reset upon the recognition unit recognizing an address of the receiver.

6. An address recognition system, comprising:
a receiving terminal and an address recognition device, wherein the receiving terminal comprises:
a recognition information generation unit configured to generate recognition information for each piece;
a positional information generation unit configured to generate positional information showing a location where the piece is received; and
a registration unit configured to store the recognition information generated by the recognition information generation unit and the positional information generated by the positional information generation unit corresponding to a server connected through a network; and
the address recognition device comprises:
a recognition information acquisition unit configured to acquire recognition information from a piece;
a search unit configured to search positional information showing locations from where the piece is received, based on the recognition information, from a server connected through a network;
a correction coefficient storing unit configured to store the positional information and a correction coefficient;
a correction coefficient change unit configured to change the correction coefficient according to the positional information;
an image acquisition unit configured to acquire images from the piece;
an evaluation value calculation unit configured to calculate an evaluation value before making a correction to location information based on the images;
an evaluation value correction unit configured to correct the evaluation value before correction with the correction coefficient and to calculate the evaluation value after the correction; and
a recognition unit configured to recognize an address of a receiver of the piece based on the evaluation value after the correction.

7. The address recognition system according to claim 6, wherein the positional information generation unit acquires spatial coordinate information by a GPS.

8. The address recognition system according to claim 7, wherein the positional information generation unit comprises:
a memory having a table in which coordinate information and positional information are correlated, and
a reading portion establishing the positional information corresponding to the coordinate information acquired by the GPS from the table.

9. The address recognition system according to claim 6, wherein the positional information generation unit generates the positional information showing the store where the piece is received according to an input operation.

10. The address recognition system according to claim 9, wherein the positional information generation unit comprises:
a memory to store a table in which information showing the store and the positional information showing locations are correlated with each other, and reads out the positional information corresponding to the information showing the store from the table.

11. The address recognition system according to claim 6, wherein the recognition information generation unit converts generated recognition information to primary or secondary codes, and prints the primary or secondary codes, and the recognition information acquisition unit reads printed the primary or secondary codes and acquires the recognition information for the piece.

12. The address recognition system according to claim 11, wherein the printed primary or secondary codes are printed barcodes.

13. The address recognition system according to claim 6, wherein the recognition information generation unit stores generated recognition information in an electric tag, and the recognition information acquisition unit reads the electric tag and acquires the recognition information of the piece.

14. The address recognition system according to claim 7, wherein the correction coefficient stored in the correction coefficient storing unit is reset upon the recognition unit recognizing an address of the receiver.

15. A method for address recognition, the method comprising:
acquiring recognition information for a piece by a recognition information acquisition unit;
searching for positional information for a receiving location of a piece from a server connected through a network;
storing the positional information and a correction coefficient in a storage unit;
changing the correction coefficient according to the positional information;
acquiring an image from the piece from an image acquisition unit;
calculating an evaluation value before making a correction to location information based on the images;
correcting the evaluation value before correction with the correction coefficient and to calculate the evaluation value after the correction; and
recognizing an address of a receiver of the piece based on the evaluation value after the correction.

16. The method of claim 15 further comprising:
resetting the correction coefficient in the storage unit upon the recognizing the address of a receiver.

17. The method of claim 15 further comprising, wherein the positional information for the receiving location is generated by a GPS.

18. The method of claim 17 wherein the storage unit in which coordinate information and the positional information are acquired by the GPS.

19. The method of claim 17 further comprising:
generating the positional information showing the store where the piece is received according to an input operation.

20. The method of claim 15, further comprising:
converting the recognition information for the piece to a readable barcode.
